(19) United States
(12) Patent Application Publication
(10) Pub. No.: US 2004/0093353 A1
(43) Pub. Date: May 13, 2004

(54) Method for multiple track time line display with document links

(76) Inventors: David Scott Leone, Drexel Hill, PA (US); David Adam Dever, Drexel Hill, PA (US); Dariusz Paul Gluchowski, Philadelphia, PA (US); Stephen Eric Anderson, Upper Darby, PA (US)

Correspondence Address: GEORGE A LEONE, SR, 2150 128TH AVENUE, NW, MINNEAPOLIS, MN, 55448, US

(21) Appl. No.: 10/628,821

(22) Filed: Jul. 28, 2003

Related U.S. Application Data
(60) Provisional application No. 60/424,984, filed on Nov. 8, 2002.

(51) Int. Cl. G06F 17/00

(52) U.S. Cl. 707/104.1

(57) ABSTRACT

A computer software method for multiple track time line display with document links by accessing digital information, where the digital information includes an information track. The digital information is displayed by juxtaposing at least two views of the information track on a display. Each view of the information track is separately scrolled and a hotspot on the at least one information track allows navigation by activating the hotspot, where the hotspot links to digital information related to the information track.

### CROSS REFERENCE TO RELATED APPLICATIONS

This application is related to co-pending provisional application of LEONE, serial No. 60/424,984, filed Nov. 8, 2002, entitled “METHOD FOR MULTIPLE TRACK TIME LINE DISPLAY WITH DOCUMENT LINKS,” and, by this reference, claims the benefit of the priority filing date of the co-pending provisional application.

### FIELD OF THE INVENTION

The present invention is related to display and navigation of digital information and, more particularly, to a method for displaying multiple information track time lines with document links.

### BACKGROUND OF THE INVENTION

Use of computer displays as demonstrative evidence in legal proceedings has been accepted in many jurisdictions. However, current methods and systems are limited in their ability to readily provide visual comparisons, while simultaneously providing links to temporally related documents. This is particularly true in a case involving data recorded over a prolonged period of time, as for example, in the case of a fetal monitoring strip. Known methods only display a single view of a fetal strip, thus making comparisons between differing views showing differing times difficult.

The present invention overcomes deficiencies in the prior art by providing a computer method that simultaneously displays at least two views of an information track or tracks. The displayed tracks have links to temporally related documents that are readily accessible for display.

### SUMMARY OF THE INVENTION

A computer software method for multiple track time line display with document links by accessing digital information, where the digital information includes at least one information track. The digital information is displayed by juxtaposing at least two views of the at least one information track on a display. Each view of the at least one information track is separately scrolled and at least one hotspot on the at least one information track allows navigation by activating the at least one hotspot, where the at least one hotspot links to digital information related to the at least one information track.

### BRIEF DESCRIPTION OF THE DRAWINGS

FIG. 1 schematically illustrates a high level block diagram of a system for multiple track time line display with document links in accordance with one example of the present invention.

FIG. 2 shows an example of a computer software program for multiple track time line display with document links as contemplated by the present invention.

FIG. 3 shows examples of information tracks as contemplated by the present invention.

FIG. 4 shows an example of a display with multiple views of an information track as contemplated by the present invention.

FIG. 5 shows an example of an explorer display window as contemplated by the present invention.

FIG. 6 shows an example of a portion of a display with search track features as contemplated by the present invention.

FIG. 7 illustrates an example of a scroll bar with jump track and dual arrows as contemplated by the present invention.

FIG. 8 illustrates an example of a hotspot overlay as contemplated by the present invention.

FIG. 9 illustrates an example of an information track including a library track graphical representation that allows users to activate hotspots linked to digital information.

FIG. 10 is a high level block diagram showing one embodiment of a scanning and software coding method as contemplated for use in the present invention.

### DESCRIPTION OF THE PREFERRED EMBODIMENT

The invention is described herein with respect to specific examples relating to fetal monitoring strips, however, it will be understood that these examples are for the purpose of illustrating the principals of the invention, and that the invention is not so limited.

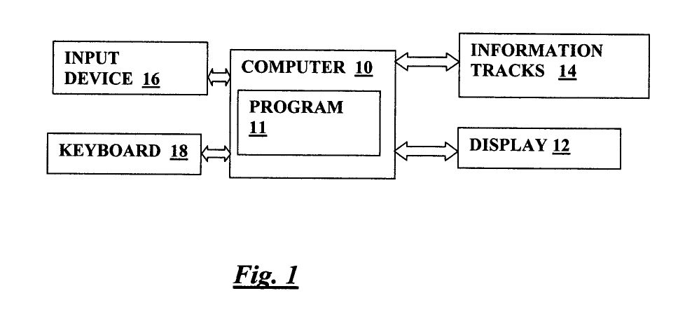

Referring now to FIG. 1, there schematically illustrated is a high level block diagram of a system for multiple track time line display with document links in accordance with one example of the present invention. The system for multiple track time line display includes a computer 10 linked to an input device 16, a keyboard 18, at least one information track 14 and a display 12.

In one example embodiment the computer 10 may be a conventional laptop computer, personal computer, or server. The input device may comprise a mouse, a touch pad, a track ball, a barcode scanner or any equivalent input device. The display may advantageously comprise any conventional computer compatible display device such as a CRT, flat panel display, and touchscreen display or equivalent device. The information tracks comprise digital information that may reside on any convenient storage media such as read only memory, magnetic discs, random access memory, optical media, digital tape or any equivalent storage media or devices. The information tracks may be stored on media in the computer housing itself, or may reside on external devices and even remote devices accessible through the Internet, an intranet or other networks.

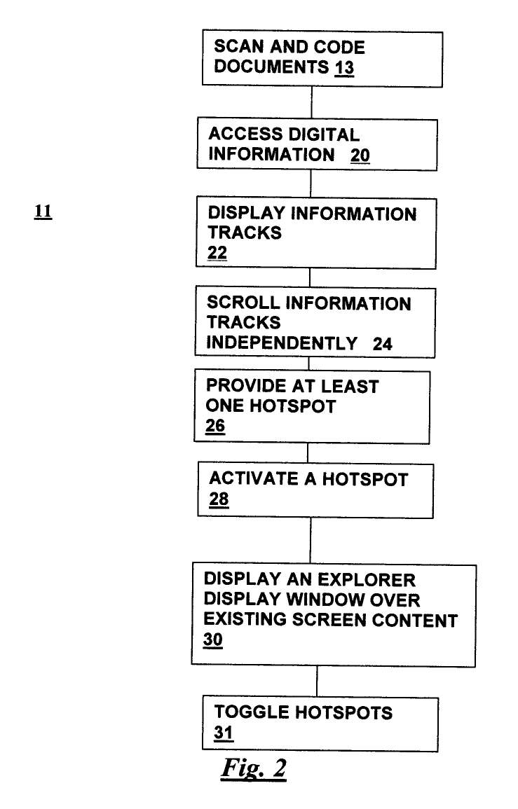

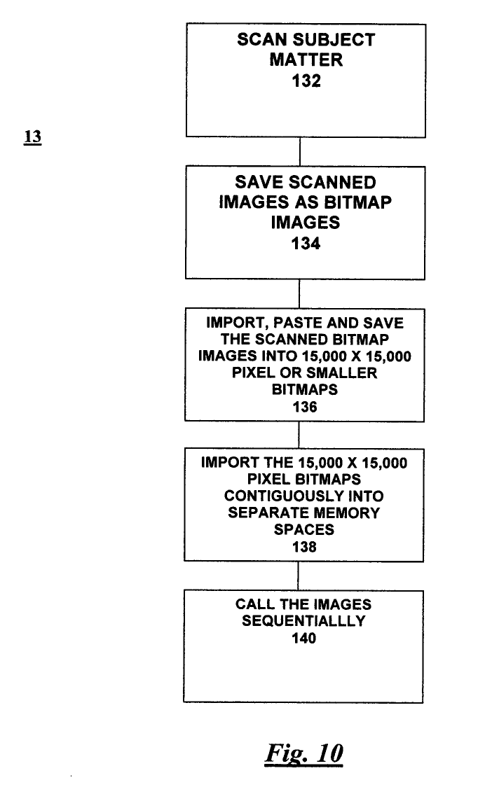

Referring now to FIG. 2, there shown is an example of a computer software program for multiple track time line display with document links as contemplated by the present invention. In one embodiment of the invention, the computer 10 includes a computer software program 11 for a computer software method for multiple track time line display with document links. In cases where digital information is not already available, documents, such as, for example, fetal monitoring strips, are converted into digital information by a scanning and software coding method 13 as described in more detail with reference to FIG. 10. The computer software program 11 includes a routine for accessing the digital information 20, where the digital information includes at least one information track 14. Once the information is accessed it is displayed by a routine for displaying the at least one information track 22 by juxtaposing at least two views of the information tracks on a display. Another routine is included for scrolling the information tracks 24. In a preferred embodiment of the invention the information tracks may be independently scrolled so as to compare portions at differing times between the two views.

The computer software program 11 further includes a routine for providing at least one hotspot 26 on the information tracks to allow navigation by activating the at least one hotspot 28, where the at least one hotspot links to digital information related to the information tracks. The computer software program 11 further includes a routine for displaying an explorer display window 30 over existing screen content. The computer software program 11 further includes a routine for toggling hotspots on and off 31 to give the user the option of having a clear view of information that may otherwise be obscured by an overlaying hotspot, for example. In one example embodiment the computer software program 11 comprises a software program in Lingo script in Director. Lingo is a script developed by Macromedia, Inc., San Francisco, Calif. 94103, US for their Director application, although any appropriate computer language may be used, such as JAVA, Visual Basic, and C++, and the invention is not so limited.

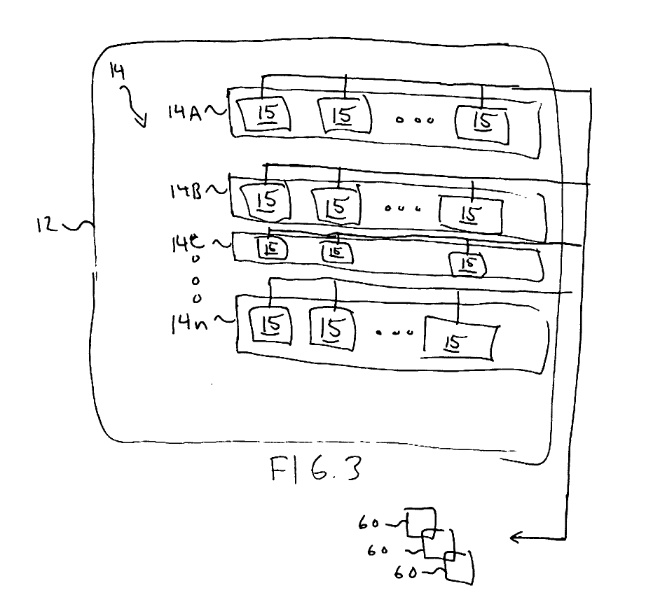

Referring now to FIG. 3, there schematically shown are examples of information tracks as contemplated by the present invention where the display 12 is in a multi-track mode for simultaneously viewing and interacting with a number of information tracks of various types. The at least one information track 14 may advantageously comprise a plurality of digital images, photographs or equivalent visual or textual data including medical strips that contain patient information on a time line. For example, at least one information track 14 may advantageously comprise images including medical strips 14A that contain patient information on a time line. One specific type of medical strip is a fetal monitoring strip 14B. The information track 14 further includes hotspots 15 to related digital information 60 that have information about activity recorded on an information track near a time marked by the hotspot 15. Library tracks 14C may also be included as an information track. In one example embodiment, the at least one information track 14 may advantageously comprise a graphical user interface.

Information tracks may be displayed as horizontal or vertical images that have any length and that can be moved across a screen using an input device. Information tracks access and display any digital information, including hotspots that can be placed over the information tracks and moved along with the information tracks to allow hyperlinks to other digital information, other tracks, explorers and/or overlays. Optionally, information tracks often contain a timeline to make temporal comparisons to other tracks or digital information.

Although information tracks are versatile and not limited to any particular digital information, there are three specialized tracks for use in medical malpractice litigation: a FetalTrack™ information track, a DocuTrack™ information track and a LibraryTrack™ information track (all trademarks owned by Nexomedia of Drexel Hill, Pa., USA). The FetalTrack™ information track contains a large image or photograph that the user can move vertically or horizontally or both. Typical images are medical strips that contain patient information such as heartbeats or other biomechanical impulses taken over long periods of time from hours to several days.

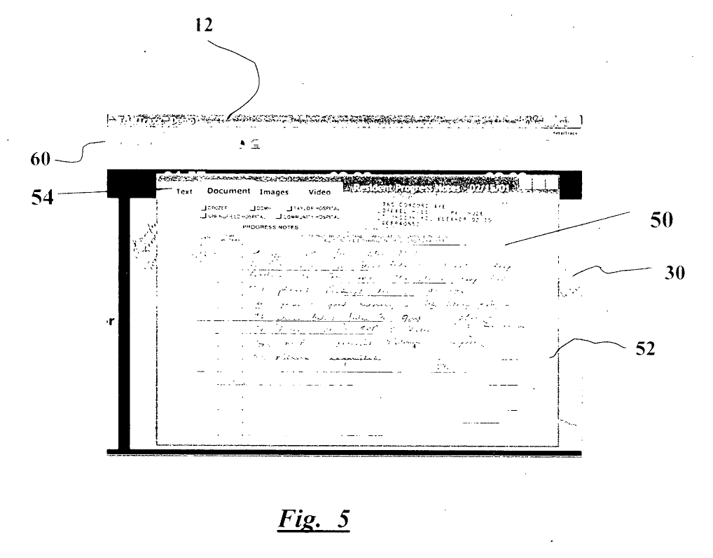

The DocuTrack™ information track is a graphical interface to any digital information typically along a timeline spanning any period of time from fractions of seconds to years. The DocuTrack™ information track contains images and hotspot links to digital information so the user can scroll the track to access digital information or to see the temporal relation between various digital information. For example, the DocuTrack™ information track can graphically display hotspots to twelve documents that were started and finished over a three day period. The user can observe, for example, when the documents were active as compared to other documents and which documents are contemporaries of one another. Additionally, the user can scroll to any hotspot representing a document and activate that hotspot to access that document, and/or access one or more information tracks 14, one or more explorer windows 50 (see FIG. 5) or other digital information 60 relating to that document. Again, the digital information can be anything from documents to video to audio and more.

The LibraryTrack™ information track is a graphical representation of a library that allows users to activate hotspots to digital information. Unlike a physical library, the LibraryTrack™ information track has unlimited shelves with unlimited length. This allows the user organize very large quantities of information with an interface that is readily understandable by even novice users. The following table presents digital information typically contained in various information tracks.

TABEL
Typical Digital Information by Information Track Type

| FetalTrack ™ Information Track | | | |
|---|---|---|---|
| 1. | Fetal Strip | | |
| DocuTrack ™ Information Track | | | |
| 1. | Admissions | | |
| 2. | Progress Notes | | |
| 3. | Discharge | | |
| LibraryTrack ™ Information Track | | | |
| 1. | Medical Records Summary, Volume I | | |
| | a. | Ultrasounds | |
| | | i. | Ultrasound 1 |
| | | ii. | Ultrasound 2 |
| | b. | History & Physical | |
| | | i. | Initial Pregnancy Profile |
| | | ii. | Prenatal Flow Record |
| | | iii. | Health History Summary |
| | c. | Consents | |
| | d. | Admissions | |
| | | i. | Admission Record |
| | | ii. | Obstetric Admitting Record |
| | | iii. | Baby Nursery Admission |
| | e. | Lab Reports | |
| | f. | Medication | |
| | g. | Operative Reports | |
| | h. | Physicians' Orders | |
| | i. | Progress Notes | |
| | | i. | Progress Notes General |
| | | ii. | Progress Notes Delivery |
| | | iii. | Delivery Room Note |
| | | iv. | Nursery Notes Baby |
| | j. | Discharge | |
| | | i. | Discharge Summary |
| | | ii. | Patient Instruction Sheet |

| 2. | Medical Records Summary, Volume II | |
|---|---|---|
| | a. | Fetal Monitor Strips |
| 3. | Hospital Policies and Procedures | |
| | a. | Ethics |
| | b. | Responsibilities |
| | c. | Hand Washing |
| | d. | Plan of Care |
| | e. | Assigning RN Care |
| | f. | Failed Induction |
| | g. | Pitocin Administration |
| | h. | PE Gel |
| | i. | Supervision Policy |
| 4. | Depositions & Interrogatories | |
| 5. | Graphs | |
| 6. | Summaries | |
| 7. | Multimedia | |
| | a. | Images |
| | _{b.} | Video |
| | _{c.} | Audio |
| Hotspots Information Track | | |
| 1. | Explorers | |
| | a. | NPN |
| | b. | RPN |
| | c. | EFM Notes |
| | d. | Care |
| | e. | RX |
| | f. | Temperature |
| | g. | P&P |
| | h. | Summaries |
| | i. | Graphs |
| | j. | Photographs |
| 2. | Overlays | |
| | a. | EFM |
| | b. | Care |

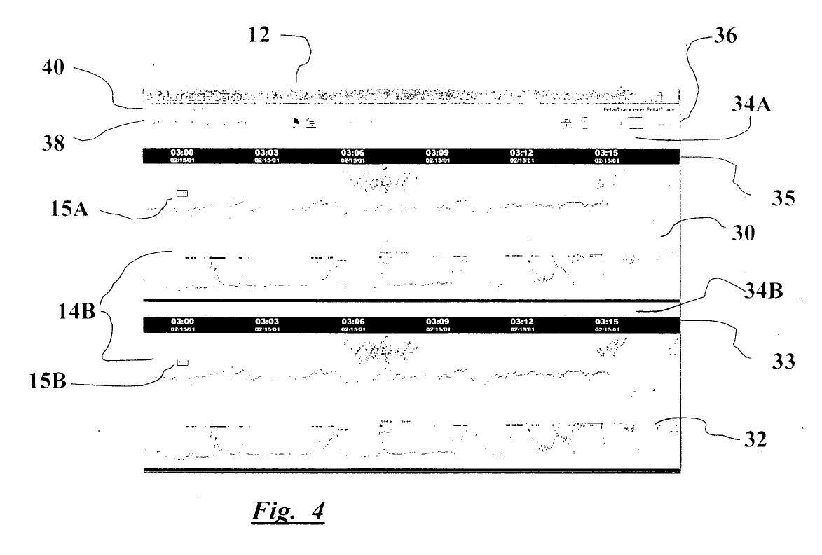

Referring now to FIG. 4, there shown is an example of a display with multiple views of an information track as contemplated by the present invention. The display 12 includes dual information tracks 14B, each having a hotspot 15A, 15B that overlays the information tracks. As explained in more detail below with reference to FIG. 8, hotspots are hyperlinked text strings or images that allow the user to navigate within the software by clicking on the text strings or images in a typical hyperlinked fashion using an input device.

With continuing reference to FIG. 4, the information tracks there shown comprise two independent views 30, 32 of the same fetal monitor strip. It will be understood by one skilled in the art having read this disclosure that the separate views do not have to be of the same information tracks 14B, but may include different information tracks. Returning to the example, note that each view of the information tracks includes a time line 33, 35 and a separate, independent scrolling bar 34A, 34B. The display also includes a drop down menu 40, a hotspot menu 38 and a search track bar 36.

Referring now to FIG. 4 and FIG. 5 simultaneously, in operation, the information tracks 14B may be separately scrolled to facilitate visual comparisons of data occurring at differing times. This is particularly useful to demonstrate differences in graphical representations for differing modes of patient health to a jury or judge in a legal proceeding, for example. The hotspots 15A, 15B may be activated, for example using an input device, to link to other information tracks, open explorer windows 50 or digital information 60 temporally related to the information track views that they overlay. For example, an event at time 03:00 may be linked by a hotspot to related digital information 60 discussing the events that happened at that time, such as a hospital record, memorandum or deposition excerpt (See, for example, FIG. 5). The digital information 60 can be brought up and overlaid on the screen for immediate viewing and subsequently closed to return to the dual views of the information tracks 30, 32. The software embedded in computer program 11 also has a routine for displaying a single information track when desired.

Referring now particularly to FIG. 5, there shown is an example of an explorer display window 50 as contemplated by the present invention. The explorer display window 50 may be displayed overlying the existing screen content, such as, for example, views 30, 32, by activating a linked hotspot or by equivalent means, such as by depressing a function key on a keyboard. The explorer display window 50 may advantageously include a view of a document with tabs 54 linked to show related information. In one example embodiment a tab 54 may advantageously host digital information, hotspots, text, tracks, documents, scrolls, images, photos, video, overlays and the like. A scroll bar 52 allows scrolling through the digital information as desired.

In a preferred embodiment, explorers have two main purposes, first, to group hotspots to like information in a menu or table of contents fashion. Second, to create windows for viewing digital information. By using tabs, these two functions can be combined within the same explorer. In addition, using tabs allows the user to access unlimited digital information within the same explorer without opening and closing separate explorers which can be cumbersome.

Each tab within the explorer can host any digital information, hotspots, tracks and overlays. In addition, using scroll bars with jump track and dual arrows, digital information that is too large to fit within the explorer can still be accessed, viewed and moved quickly within the explorer.

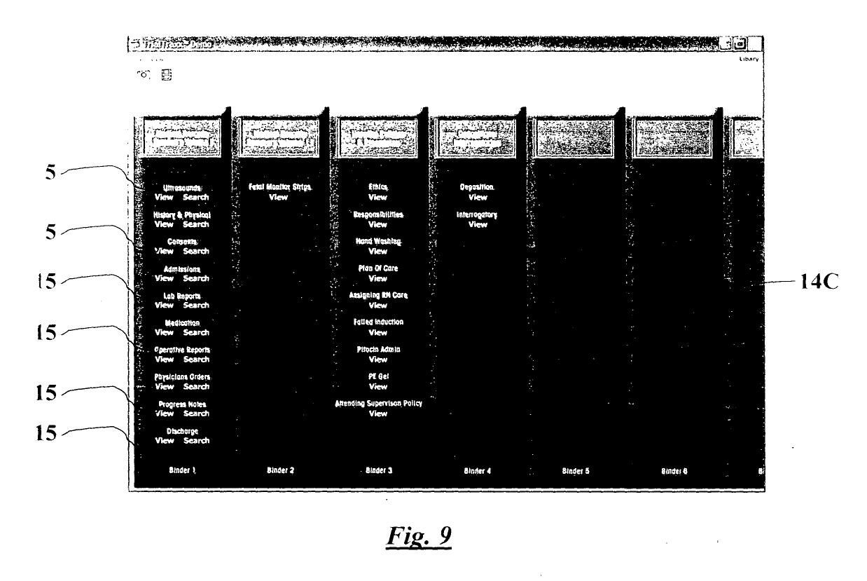

Now referring to FIG. 9, in one example embodiment the at least one information track 14 may comprise a graphical user interface to digital information further comprises a library track 14C including a library track graphical representation of a library that allows users to activate hotspots 15 to digital information.

Referring now to FIG. 6, there shown is an example of a portion of a display with search track features as contemplated by the present invention. The search track 36 features include a mode for synchronizing and/or locking the movement of multiple tracks when in the multitrack mode by activating the lock icon 62. The synchronizing and locking mode can be toggled on or off to allow free movement of tracks when in multitrack mode. The search track 36 features also include a keyword search feature accessed through entering a search term in window 63 and activating icon 64 to access predefined portions of a track. The user can vary the movement speed of the tracks from slow to fast and anywhere in between by setting a scroll rate, for example, a scroll rate in a relative range between 1-10, in a scroll speed mode 66.

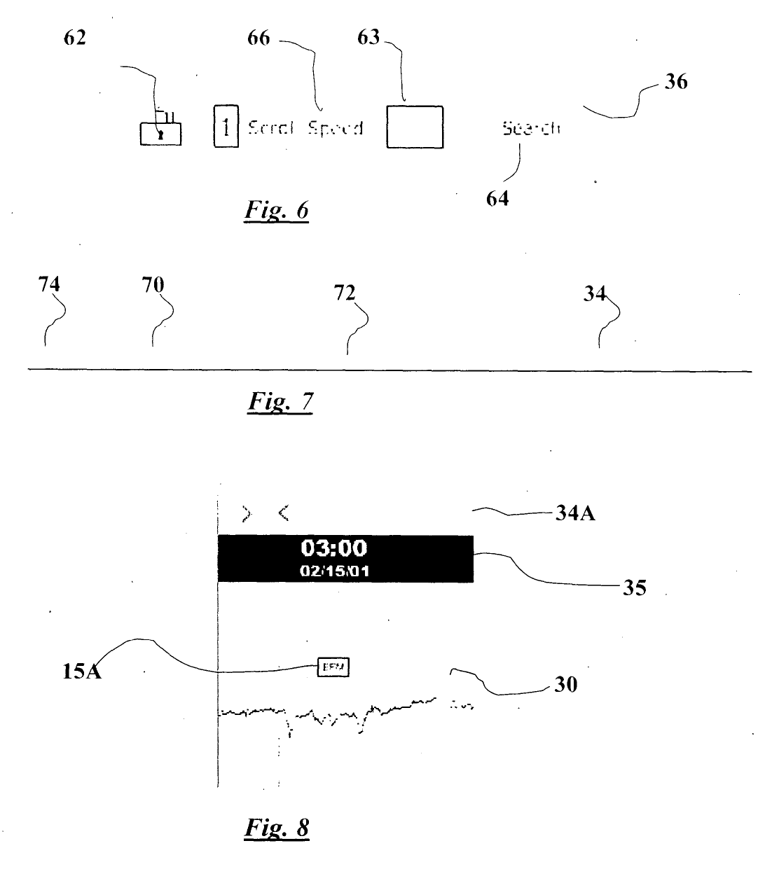

Referring now to FIG. 7, there illustrated is an example of a scroll bar 34 with jump track 72, shuttle 70 and dual arrows 74 as contemplated by the present invention. A user with an input device can move digital information and tracks using a scroll bar. The scroll bar has a typical shuttle to jog the digital information on the screen. However, the shuttle rides along a unique hyperlinked track with a one to one correlation between the length of the track and the virtual length of the digital information. So when the user activates a position on the track with an input device, the user is hyperlinked to the position of the digital information that directly corresponds to the location activated on the hyperlinked track. Additionally, the scroll bar has double opposing arrows on both ends of the track. This allows the user to move the shuttle in either direction along the track from either end of the scroll bar, which is especially advantageous when operating th software on a large touchscreen.

Referring now to FIG. 8, there illustrated is an example of a hotspot overlay as contemplated by the present invention. The hotspot 15 is overlaid on an information track 30. The hotspot 15 may preferably correlate with an event temporally corresponding to the time noted on the time line 35. Hotspots can hyperlink to digital information inside or outside of the document, tracks, explorers and overlays. Using hotspot overlays, the user can toggle on or off the presence of hotspots. For example, while at times the user may want to see and activate hotspots on an image, there are times when the user may not want to see or activate the hotspots because they block portions of the image or they make too much digital information available. Thus, by overlaying hotspots on the image and designating a toggling hotspot for the hotspot overlay, the user can toggle the hotspots on or off. Hotspot overlays can be used alone or in conjunction with other digital information, tracks, explorers and even other overlays through nesting. Users can print any digital information using a print hotspot. The print hotspot activates code embedded within the software that selects the digital information, scales it to fit within a designated paper size and sends it to a printing output device.

Now referring to FIG. 10, a high level block diagram of the scanning and software coding method 13 is schematically shown. Scanned images and bitmaps have size limitations based on the bitmap format used. Additionally, typical “off the shelf” software currently has pixel limitations of 30,000 pixels based on memory restrictions of most personal computers where caching single images larger than 30,000 pixels for display makes the computer unstable. Thus, viewing, editing, accessing and moving images is limited to 30,000 pixels across and/or vertically. Using the scanning and software coding method 13, any number of images can be virtually stitched to make a patchwork image of unlimited length and height that can be viewed, accessed and moved within the software as one image without making the computer unstable.

First, the subject matter 132 is scanned using a typical high resolution scanning device (not shown) in increments or sizes that can be accommodated by the scanner but not larger than 15,000×15,000 pixels. The scanned images are saved as bitmap images in step 134. The scanned bitmap images are imported, pasted and saved into 15,000×15,000 pixel or smaller bitmaps at step 136 using bitmap editing software. Step 138 imports the 15,000×15,000 pixel bitmaps contiguously into separate memory spaces, such as layers, in a vector based animation program of choice such as Macromedia Flash, Adobe GoLive or similar vector based animation programs. The bitmap images are sequentially called at step 140 using the vector based animation program's native script or language. The scanning and software coding method 13 is not limited to vector based animation software. It can be implemented using any custom program that displays multiple bitmap images.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices and reconstruction algorithms, and that various modifications, both as to the equipment details and operating procedures, may be accomplished without departing from the true spirit and scope of the present invention.

What is claimed is:

1. A computer software method for multiple track time line display with document links comprising the steps of:
accessing digital information, where the digital information includes at least one information track;
displaying the digital information by juxtaposing at least two views of the at least one information track on a display;
independently scrolling at least one view of the at least one information track; and
providing at least one hotspot on the at least one information track to allow navigation by activating the at least one hotspot, where the at least one hotspot links to digital information related to the at least one information track.

2. The method of claim 1 further comprising the step of displaying the related digital information when a hotspot to the related information is activated.

3. The method of claim 1 further comprising the step of scrolling one or both views of at least one information track to juxtapose differing views of the same information track for comparison.

4. The method of claim 3 wherein the at least one information track comprises images including medical strips that contain patient information on a time line.

5. The method of claim 1 wherein the at least one information track comprises images including medical strips that contain patient information on a time line.

6. The method of claim 5 wherein the at least one information track comprises hotspots to documents that relate to activity recorded on the at least one information track temporally related to a time marked by the hotspot.

7. The method of claim 1 wherein the at least one information track comprises hotspots to documents that have information about activity recorded on the at least one information track near a time marked by the hotspot.

8. The method of claim 1 wherein the at least one information track comprises a graphical user interface to digital information.

9. The method of claim 8 wherein the graphical user interface to digital information further comprises a library track including a library track graphical representation of a library that allows users to activate hotspots to digital information.

10. The method of claim 9 wherein the graphical user interface to digital information further comprises a document track including a document track graphical interface to digital information along a timeline.

11. The method of claim 10 wherein the document track further comprises images and hotspots to digital information allowing scrolling along the document track to access digital information.

12. The method of claim 1 further comprising the step of displaying an explorer display window over existing screen content.

13. The method of claim 12 wherein the explorer display window further comprises a combination of tabs and scroll bars to access and display digital information, tracks, hotspots and/or overlays.

14. The method of claim 1 further comprising the step of activating a multi-track mode for simultaneously viewing and interacting with a plurality of information tracks of various types.

15. The method of claim 14 further comprising the step of synchronizing and/or lock the movement of a plurality of information tracks when using the multi-track mode.

16. The method of claim 1 further comprising the step of varying scrolling speed of the at least one information track.

17. The method of claim 1 further comprising the step of keyword searching to access predefined portions of the at least one information track.

18. The method of claim 1 further comprising the step of toggling the presence of hotspots on and off.

19. The method of claim 1 further comprising the steps of opening an display window for grouping hotspots to like information in a menu or table of contents fashion, and for viewing digital information.

20. The method of claim 19 wherein the explorer display window includes tabs for combining functions.

21. The method of claim 20 wherein a tab can host digital information, hotspots, tracks and overlays.

22. A computer software method for multiple track time line display with document links comprising the steps of:
scanning and coding documents into digital information;
accessing the digital information, where the digital information includes at least one information track;
displaying the digital information by juxtaposing at least two views of the at least one information track on a display;
independently scrolling at least one view of the at least one information track; and
providing at least one hotspot on the at least one information track to allow navigation by activating the at least one hotspot, where the at least one hotspot links to digital information related to the at least one information track.

23. The method of claim 22 where the step of scanning and coding documents into digital information further comprises the steps of:
scanning at least one document to create scanned images;
saving the scanned images as scanned bitmap images;
importing and saving the scanned bitmap images into pixel bitmaps;
importing the pixel bitmaps contiguously into separate memory spaces; and
sequentially calling the pixel bitmaps.
